(19) United States
(12) Patent Application Publication
(10) Pub. No.: US 2016/0301141 A1
(43) Pub. Date: Oct. 13, 2016

(54) Radio Communication System With Antenna Array

(71) Applicants: Byron Del Castillo, Las Vegas, NV (US); Allen Higgins, Medina, OH (US)

(72) Inventors: Byron Del Castillo, Las Vegas, NV (US); Allen Higgins, Medina, OH (US)

(21) Appl. No.: 14/267,850

(22) Filed: May 1, 2014

Related U.S. Application Data
(60) Provisional application No. 61/936,313, filed on Feb. 5, 2014.
(60) Provisional application No. 61/818,008, filed on May 1, 2013.

(51) Int. Cl. H01Q 11/10; H01Q 21/00; H01Q 1/24

(52) U.S. Cl. CPC H01Q 11/10; H01Q 1/243; H01Q 21/00

(57) ABSTRACT

A communication device is provided that has two or more antenna arrays such that each array comprises two or more antenna pairs. The antenna pair includes a first antenna and a second antenna linked to a common radio. The first antenna and the second antenna receive the same incoming wireless signal and wirelessly transmit the same outgoing signal. Also provided are two or more radios, each of the two or more radios are connected to an antenna array such that each radio includes a receiver configured to receive the incoming wireless signal and a transmitter configured to transmit the outgoing signal. An interface is provided to connect to a wired communication channel to thereby interface the two or more radios to the wired communication channel. A central controller is configured to control the exchange of data between the interface and the two or more radios.

### PRIORITY CLAIM

This application is related to, claims the benefit of and priority to U.S. Provisional Patent Application No. 61/936,313 filed Feb. 5, 2014, and U.S. Provisional Patent Application No. 61/818,008 filed May 1, 2013.

### FIELD OF THE INVENTION

This invention relates to communication antenna and in particular to an antenna configured providing increased range and capacity.

### RELATED ART

Communication antennas are used to transmit and receive wireless signals between electronic devices. One common environment of use for an antenna is in a data communication network, such as Wi-Fi environment. In these environments, the antenna would be linked to a receiver and transmitter to receive and transmit wireless signals.

Prior art antennas and the associated systems suffer from numerous drawbacks. One such drawback is a lack of range and limited coverage area. The range of the antenna and the transmit power levels control the distance in which a fixed or mobile transceiver may be located and still conduct successful communication with the system. Some prior antenna designs are omnidirectional and hence radiate energy in all directions. For example, a prior art home system may have two dipole antennas connected to a radio and each antenna is ¼ wavelength apart. Because the transmit energy is radiated in all directions, the range suffers in any one linear direction from the antenna. This also results in crosstalk and interference.

To extend the range, unidirectional or dipole antennas have been proposed, but these antennas also have associated drawbacks. Due to the directional nature of these antennas, the range in any one direction is extended, but a device located in another direction may not receive coverage.

A further drawback to this prior art system is limited capacity. Prior art systems quickly become overloaded when the number of concurrent users increases. This undesirably slows data throughput and if the number of users is further increased, the system may become overloaded and become functionally unstable.

In addition, although wireless mobile or fixed base communications systems have been distributed and used widely, such networks suffer from low bandwidth and coverage due to constraints within the physical media, user capacity, cost, environmental restrictions, regulatory restrictions and overall network design and implementation issues. This results in users suffering dropped communications links and calls or slow or intermittent access.

One proposed solution has been centralized multiple transceiver wireless control systems for locally distributed devices or units. However this solution is still not widely distributed today or practiced. Though 802.11 in its form as WIFI and others such as TDMA, LTE and GSM are common place in a point to point or point to multipoint configuration they still suffer through capacity and bandwidth concerns. For example, Wireless Access Points, Base Stations, FemtoCells, and others) suffer from poor hardware, hardware configurations, and network design principles.

As an example, in a common hardware configuration, including the newly adopted 802.11ac equipment. The radio in a raw data (Non TCP-IP) format is claimed to be capable of providing up to 1.25 Gbps using six antenna chains (6×6). The controller board which has the radio attached may contain 2 or more Gigabit Ethernet ports (NICs). One is used for connection to the service providers WAN feed, the others for additional hardware (PC's, etc.). It may also contain two or more radios (although usually no more than two in a typical home unit, one operating in the 2.4 GHz band the other in the 5 GHz band. However, even if there are two 802.11ac radios, or one 802.11ac radio and one 802.11n, in both instances the total bandwidth capable of being provided or downloaded wirelessly is either 2.5 Gbps or 1.75 Gbps. The switching fabric of the controller must now be capable of exceeding the potential full wireless bandwidth. In 100% of the cases where multiple high speed radios are used the switching fabric cannot support the total bandwidth. Also, if equipped with the two 802.11ac radios as an example, the backend bandwidth is no more than 1 GBps, or less than 980 Mbps for the Ethernet (NICs) port. So as a result the full bandwidth capabilities of the radios are not achieved.

To overcome the drawbacks of the prior art and provide additional benefits, an improved radio and antenna design is disclosed.

### SUMMARY

The system and method disclosed herein is configured to establish total available capacity to be consistent from the backend of the systems and ultimately to the user. Content critical deployments are not hampered by slow data streams or overwhelmed by too many users. The radio nodes are designed to create multiple RF layers over an area, and in one embodiment each layer is independently fed by multipolar MIMO antennas which can also be adjusted to tailor the coverage's within each layer. The antenna arrays can be custom tailored for each area or zone. This ensures better coverage and reliability beyond what is capable with traditional beam forming technologies. From large stadiums comprising of bleachers and stands to press boxes or suites, coverage can be independent or uniform designed to the specific need or requirement. Each of these layers can operate within the same geographical area, such that one layer is configured and used to service sports wagering, another live video feeds from the playing field, and the third taking orders for drinks and food all directed to the same devices and selectable by the user.

These multiple radio MESH nodes (or none mesh nodes) as described herein can be configured with multiple radio meshes to relay communication and provide redundancy, and use multi-polarized antennas by having each antenna in the array at 90 degrees to the other antenna in the array and each antenna (plane) is separately fed to the same radio RF port or to separate ports on the same radio. The antennas operate with any wireless standard including technologies like 802.11ac.

The communications devices disclosed herein utilize embedded multicore processor technology capable of supporting the needs of thousands of users per node and tens of thousands when more than one unit is deployed in conjunction with a parallel processing system, referred to as Hyper Imbedded Parallel Processing Operating System wireless controller. This parallel processing technology is capable of processing many millions of transactions per second and the nodes can handle millions of data points more efficiently than any other controller based wireless system with security. Each node can contain up to 8 radios, and can be stacked up to 24 radios or more. This results in a capacity of close to 2,400 associated users depending on customer configuration on a basic node.

Lastly the radio nodes described below in greater detail are each capable of being equipped with a proprietary WIPS (Wireless Intrusion Protection System) that not only monitors for rogue networks, but also acts proactively and target the individual wireless intruders offensively and not just in a passive manner to ensure the wireless networks performance is not affected.

As features of the communication device disclosed herein are wireless Intrusion Protection System (WIPS), anti-hacking and anti-denial of service capability system, real-time intrusion protection, an offensive protection option (not just passive). In addition, installed costs are normally 40-50% lower than major competitors due to increased coverage of each communication device, signal range can be made to be over 1+ miles. Additional features also include geo-location and geo-fencing controls for tracking, built-in optional GPS, universal coverage-‘in-room’, public areas, perimeter of property, city wide, enhanced mesh linkage capability for broad city-wide coverage areas, and multipolar antenna design.

In various embodiments the communication device may be equipped with GigE network capability and ultra wide band, dual feed multipolar (XYZ-Axis) antenna designs. Roaming between sectors is possible. The communication device may connect to a hard wired cable, such as any metallic or optic cable. In one embodiment, the communication device utilizes a 2.5 Gbps fiber channel to offload and receive data. This may also be expandable to a 10.2 Gbps capacity. In one embodiment, the communication device includes 6 GigE Ethernet ports. It is contemplated that any number of radios and associated antenna arrays may be provided one embodiment eight radios are provided while in another embodiment four radios are provided. The radios may be 802.11n that may operate in the 2.4 GHz or 5 GHz range.

As an improvement over the prior art the communication system enclosed below overcomes the limitations of the prior art thus allowing for full capacity and performance. This increase in performance can benefit media rich wireless environments at home, office, commercial locations and in wide area deployments. Gaming, video and other high bandwidth applications will operate fully unrestricted and concurrently. Also as applied to portions of this application as they relate to regulated, and non-regulated gaming the available increases in bandwidth as proposed will, for the first time in a wireless environment, allow for live distributed play and data collection. These systems can be used in any environment that utilizes wireless communications. For example, instances of poker and bingo as an example can now be played online wirelessly among thousands of players using fixed and mobile wireless devices or appliances. Live play between wirelessly connected video play machines (slot machines, video poker machines, and virtual game consoles) can now also be more distributed without performance degradation issues or reliance on wired infrastructure.

For example, in one embodiment the system is enabled to deploy wireless virtual poker platforms without the need for wired infrastructure capable of having virtual dealers all in one location and players distributed across an entire city playing at virtual tables and others joining from mobile devices simultaneously. In addition, entire locations, even cities or communities, could play a live remote hosted bingo game and with this technology application thousands of players can join without the need for a fixed location bingo hall. Alternatively in some instances players, both mobile and at home, can join a game played at a location bingo hall as virtual wireless participants.

Another instance of a problem improved upon by this method and apparatus, is user capacity, and bandwidth as related to a wide area deployment (i.e. Hotspot). In a typical environment, if each of these nodes is equipped with a single 802.11g radio it has a max user capacity of approximately 6 active connections with 8-12 non-active connections. Active is defined as a user surfing, downloading, etc. In an 802.11n deployment using a single radio, the active users increase to only 60 and up to only 180 inactive. Mix mode deployments can suffer up to a 50% decrease or more in available capacity. Also, processor speed and memory capacity can substantially reduce the capacity. The system disclosed herein uses of multiple radios simultaneously and the radios are further controlled by a central core processor to increase the number of active/non-active users within a defined area by a multiple of over ten times. Such an increase will have a notable effect on wide area distribution of wireless data in locations such as hotels, convention areas, stadiums and other location where thousands of people may gather at any one time.

In one embodiment disclosed is a communication device, having two or more antenna arrays such that each array comprises two or more antenna pairs. The antenna pairs include a first antenna and a second antenna linked to a shared radio. The first antenna and the second antenna are both configured to receive an incoming wireless signal and wirelessly transmit an outgoing signal. This embodiment includes two or more radios and each of the two or more radios connect to one or more antenna arrays. The radios are configured with a receiver configured to receive the incoming wireless signal from the antenna pair and process the incoming wireless signal to create received data. The radio also includes a transmitter configured to process outgoing data into an outgoing signal, and present the outgoing signal to the antenna pair. An interface is configured to connect to a wired communication channel and send received data from the two or more radios to the wired communication channel and present outgoing data from the wired communication channel to the two or more radios. A central controller in communication with the two or more radios and the interface is provided to control the exchange of outgoing data and received data between the interface and the two or more radios.

It is contemplated that the first antenna and the second antenna may be symmetrically offset and angled from a center axis such that the center axis defines a center axis of a sector served by the first antenna and the second antenna. In one embodiment, the communication device further comprises electrical connections between each antenna array and each radio, such that electrical connectors of an antenna array to the radio are identically matched for physical characteristics and impedance.

The first antenna and the second antenna are established at a different angle and are configured to receive the same signal but present a different signal magnitude to the radio due to the different angle of the first antenna in relation to the second antenna. The antenna arrays may be assigned to a single sector and the coverage area of the communication device may be divided into multiple sectors. The coverage area of the communication device may be circular and each sector is defined by an arc in the circular coverage area. In one embodiment, at least one antenna pair is movable between a first position and second position during operation of the communication device based on control signals from the central controller.

Also disclosed is a base station for wirelessly exchanging data between a remote server and a mobile communication device. In this embodiment the base station includes a housing having a top, a bottom, and an outer side wall defining an outer circumference. An input/output interface is part of the base station and configured to connect to a communication cable and control the sending of received data over the communication cable. Two or more antenna arrays are configured to receive and convert wireless signals from mobile device to electrical incoming signals. The antenna arrays comprise an antenna bracket, the antenna bracket establishing a central axis. The bracket may mount to the aluminum plate discussed below, which may be grounded. Also part of the antenna array is a first antenna positioned on the antenna bracket facing toward the outer side wall at a first angle relative to the central axis. A second antenna is positioned on the antenna bracket facing toward the outer side wall at the first angle relative to the central axis but in an opposing direction. Also part of this embodiment is a radio associated with each antenna array. The radio is configured to receive and process the incoming signals from the antenna array. A central controller is provided to coordinate operation of the radios and the input/output interface to establish transmission of the incoming signals over the communication cable as data signals.

In one embodiment, the antenna arrays are aligned to face the outer circumference of the side wall and extend in a generally circular layout around the outer circumference. It is contemplated that the outer circumference may be divided into four or more sectors and each sector is assigned one or more antenna arrays. In one configuration, the first antenna and the second antenna are log periodic antennas. Each radio may connect to one or more antenna arrays. The base station may include two or more antenna arrays and each antenna array includes two or more antennas. It is contemplated that the antenna mount be movable between a first position and a second position to concurrently change the position of both the first antenna and the second antenna.

Also disclosed is a radio system and antenna array for a wireless communication device that is configured to send and receive wireless communication in a sector. The system comprises two or more radios configured to processes signal from two or more antennas and two or more antenna arrays. Each antenna array includes two or more antennas and each of the antennas in the antenna array is connected to the same radio and the antenna array is assigned to handle communication in only one sector. A sector is less than a total coverage area for the wireless communication device, and each of the antennas has a log periodic offset and is mounted in a mirrored offset and angle relative to the other antennas in the antenna array. This establishes wireless signals transmitted from an antenna as having a rotating field with non-vertical and non-horizontal polarization.

In one embodiment, each antenna in the antenna array has a different rotating polarization which is non-vertical and non-horizontal polarization. In one configuration, each radio services two or more antenna arrays and each antenna array presents the same signal to the radio. The system may further include a central controller and an input/output interface such that the central controller is configured to coordinate operation of the two or more radios with the input/output interface. In addition, the central controller may be further configured to adjust an angle of all the antennas in at least one antenna array relative to a horizontal plane.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates an example environment of use.

FIG. 2 illustrates a block diagram of an example embodiment of a central controller with transceiver units.

FIG. 3 illustrates a block diagram of an example embodiment of a transceiver unit having two or more antennas.

FIG. 4 illustrates a top view of an exemplary antenna sector layout for an antenna array having a circular coverage pattern.

FIG. 5 illustrates a top view of an antenna array with paired antennas.

FIG. 6 illustrates a side view of the exemplary antenna sector layout as shown in FIG. 4.

FIG. 7 illustrates a side view of an exemplary antenna pair.

FIG. 8 illustrates a top plan view of a single antenna.

FIG. 9 illustrates a top view of an antenna bracket.

FIG. 10 illustrates a side view of an antenna bracket with pivot.

FIG. 11 illustrates a front perspective view of the bracket with antennas.

FIG. 12A illustrates a perspective view of the an exterior housing or an eight radio base station

FIG. 12B illustrates a perspective view of an exterior housing or two stacked eight radio base stations to form a 16 radio configuration.

FIG. 13 illustrates an expanded view of an eight radio base station.

FIG. 14A illustrates a prior art base station with coverage area.

FIG. 14B illustrates coverage areas for multiple sectors in the radio configuration of FIG. 13.

FIG. 15 illustrates an expanded view of an alternative embodiment of a radio configuration.

### DETAILED DESCRIPTION

The present invention is directed to a wireless communications system and software application methodology that is particularly effective in a variety of locally and remotely distributed configurations.

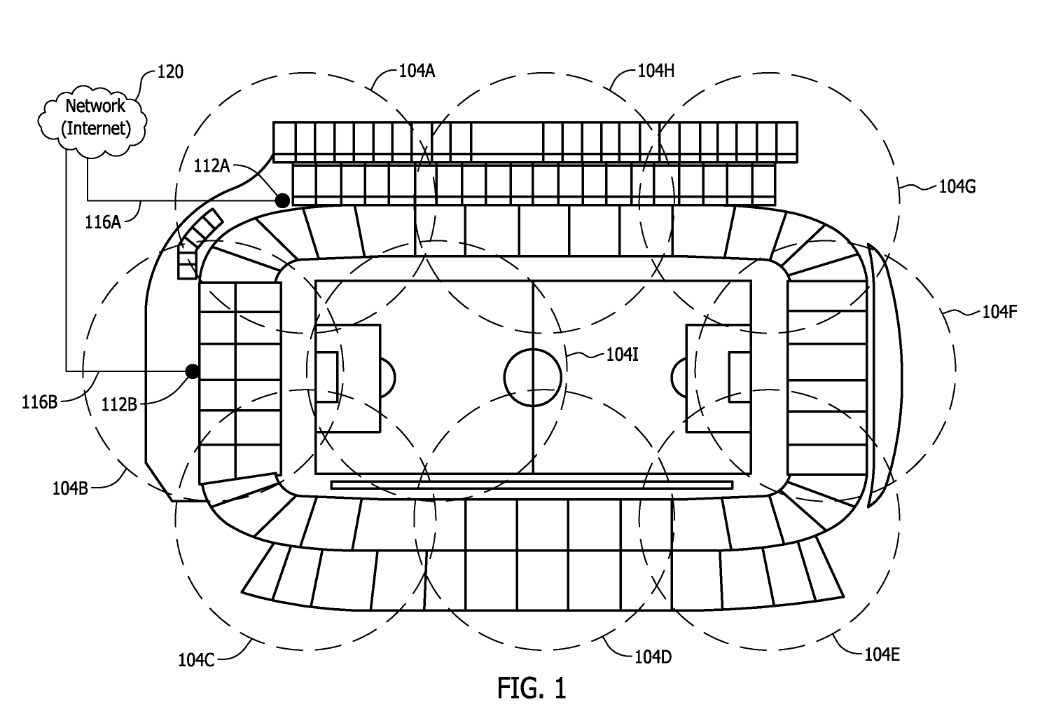

FIG. 1 is an example environment of use in the form of a sports or event stadium. While the communication system described herein may find use in any environment, one example environment of use is in a stadium or event center. Current technology is quickly overloaded by the large volume of users. For example, a stadium that may contain in excess of 10,000 people, and often in 50,000 people. In a traditional deployment multiple access points would be operated in the 2.4 GHz bands to provide some form of service. Based on three available channels in the band, and some form of frequency reuse in the deployment the max amount of active users at any one time is often limited to no more than 300, in a pure 802.11n deployment, and 54 in an 802.11g. As a result, it would take hundreds of base stations to provide coverage. Nine prior art base stations cannot provide adequate coverage to this stadium deployment.

The method and apparatus disclosed herein establishes an HD (High Density) distributed wireless network. Instead of only hundreds of participants, thousands may join the networks simultaneously. Using an example environment of a stadium as shown in FIG. 1, the same distribution of base units configured as disclosed herein, the basic HD version will be capable of providing over 2000 non-active links per basic node with 688 active users at 1 Mbps per user, and over 890 users with over 2600 non-active at 768 Kbps per user. Advanced HD version nodes will be capable of providing over 1376 active users per node and more. In reference to FIG. 1, the stadium model the 9 HD nodes coverage zones 104A-104I will increase total system capacity to 12,384 active users versus 300 and cover over 37,152 non-active users at one time. This is a significant increase over the prior art.

Part of each coverage zone 104 is a multi-radio and multi-antenna communication device 112. In FIG. 1 only communication devices 112A, 112B are shown but it is contemplated that each coverage zone 104 may have an associated communication device 112. Connecting the communication device 112 to a network 120 (such as for example the Internet) is a hard wired communication link.

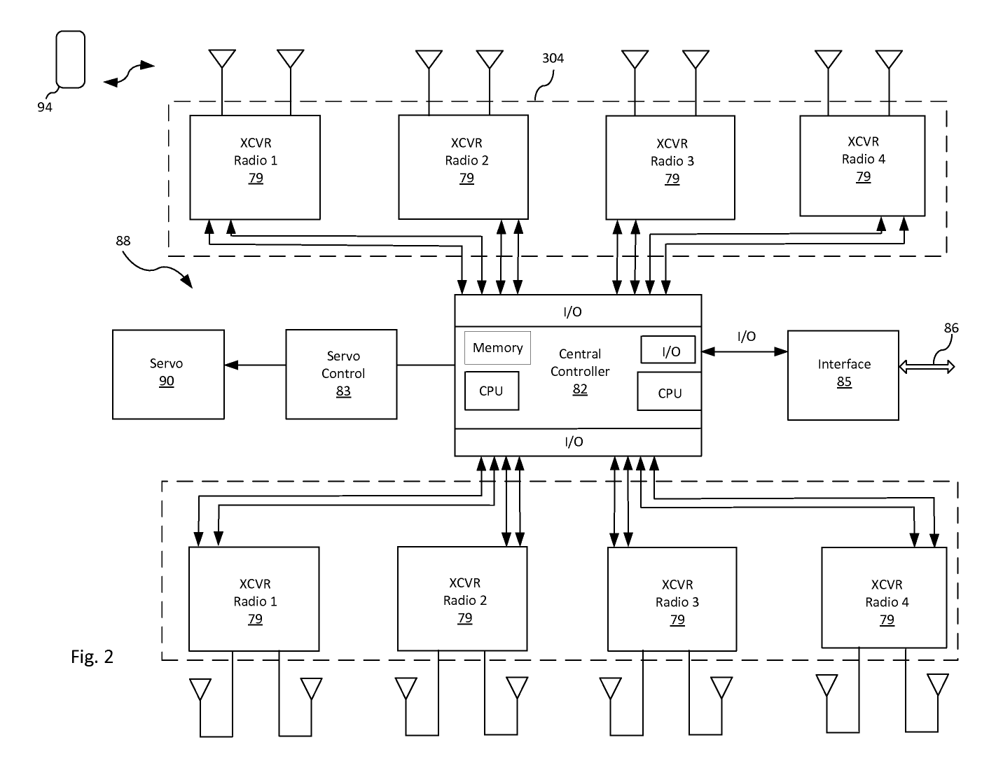

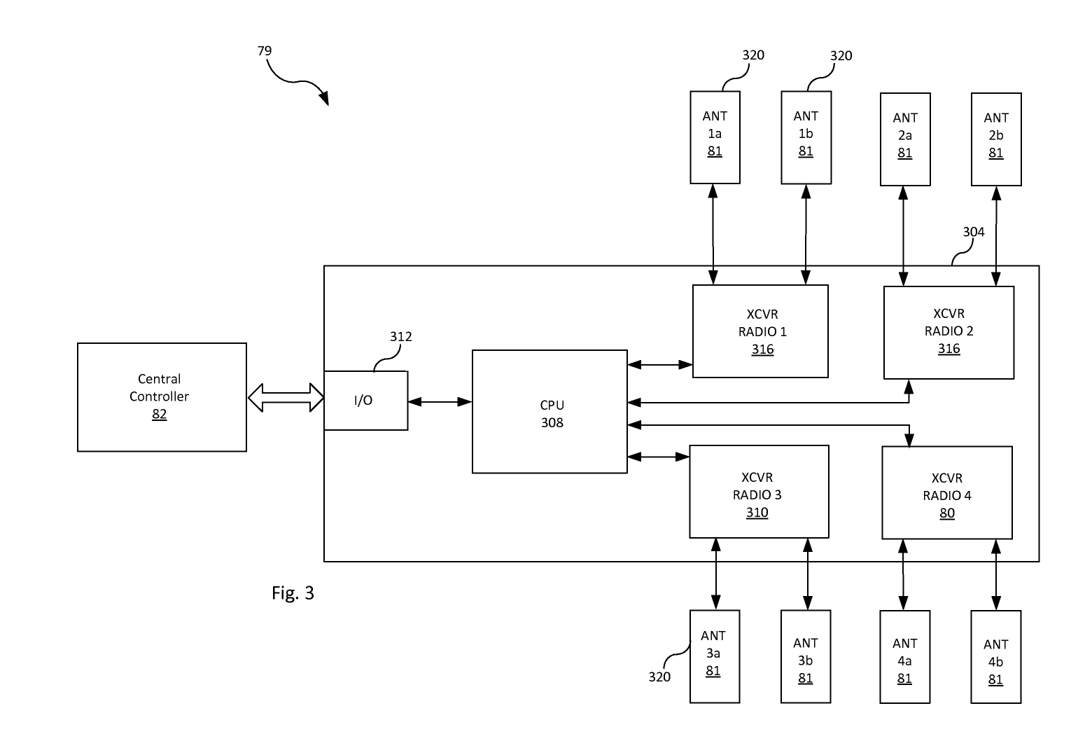

FIG. 2 illustrates a block diagram of a central controller with transceiver units. This is but one possible layout and arrangement of elements for the communication system described herein. This system may be referred to herein as a access point 88 (or central node). In FIG. 2, antennas are not shown, but antennas are contemplated to be part of this configuration. The access point 88 is comprised of one or more transceiver radio boards 304 which include multiple wireless radios 79 (shown in FIG. 3). The transceiver radios 79 all connect to a central controller 82 as shown. Communication between the transceiver radios 79 occurs to effect data transfer between devices.

The central controller 82 includes one or more CPUs, memory and one or more input/output interfaces configured to interface with the transceiver units 79. The CPU is configured to execute machine executable code that is stored in the memory. The machine executable code, often referred to as software, may be configured to perform parallel processing on the various streams of input and output date traveling to and from the transceiver radios 79. The parallel processing capability is optional as the system may be configured with or without parallel processing. In one configuration, there are two central controllers (each configured as a separate circuit board) located in the access point 88. These two central controller 82 boards may be arranged on top the other or sandwiched together. The central controller boards may be linked by one or more cables or other means to exchange data. In one embodiment, teach central controller independently connects to an external communication path. It is also contemplated that one or more of the sectors may be used to backhaul data to and from the access point 88 (central node). Any interconnection protocol may be used to electrically interconnect any device within the board. In one embodiment, Ethernet and PCI based communication is used.

As described below, each transceiver radio 79 is configured to process communications within one or more sectors. As a result, incoming communication, identified by an IP address, must be routed to the proper transceiver radio 79, associated with a sector in which the user is located. In this embodiment, each radio board 304 has four radios 79, with two antennas connected to each radio. The connections between the radios 79 and the central controllers 82 may be CAT6 type cable.

The central controller 82 connects to an optional interface 85. The connection may be either through fiber optic line, Ethernet cabling, any type cable or a direct trace connected to a multicore (CPU) device. The interface 85 could also be on board or within the same integrated circuit or in an attached circuit board.

In one embodiment, the central controller 82 will be operating using multiple instances of a parallel operating system, each of which may function within a single core. In other embodiments, the parallel processing is distributed across multiple cores.

In one embodiment, the interface 85 connects to a high bandwidth communication path such as Ethernet, fiber optics, coaxial cable, or any other type communication standard or path capable of high bandwidth input/output. The interface 85 may be a LAN to fiber converter. The channel 86 may be a fiber optic cable and connect to a switch or server, not shown. Four different access points 88 may connect by fiber connection to the server or switch (main controller).

In one embodiment, the access point 88 includes one or more servo controller 83. The servo controllers 83 in turn connect to one or more servos 90. The servos 90 are mechanically or magnetically linked to one or more antennas or antenna mounts. The antennas and antenna mounts are described below in greater detail. The optional one or more servo controller 83 and the one or more servos operate in unison to adjust the angle, location, or other physical aspect of the one or more antenna. In one embodiment, each servo controls a linked pair of antennas such that each antenna in an antenna pair moves at the same time and in the same direction. In other embodiments, it is contemplated that the antenna may be de-linked in motion to thereby position each antenna differently and uniquely.

In operation, the access point 88 performs communications in one or more fixed or mobile units 94 (collectively referred to as user). The user may use any type device capable of communicating over a wired or wireless to communicate with the access point 88. Exemplary fixed or mobile devices include but are not limited to smartphone, smart watch, tablet, laptop computer, desktop computer, or any other mobile or stationary device with wireless communication capability. The communication standard under which communication occurs may be any type communication standard currently in use or developed in the future.

FIG. 3 illustrates a block diagram of an example embodiment of a transceiver unit having two or more antenna. In reference to FIG. 2, the system of FIG. 3 corresponds to a transceiver unit 79. In this embodiment, the antennas 81 are shown as would be included in the embodiment of FIG. 2. In this example embodiment, an individual radio control board 304 is comprised of one or more radio modules 316. In this embodiment, each control board 304 includes four radio modules 316, but in other embodiments, any number of radio modules may be included. In one embodiment, the radio modules 316 comprise GW2388-4 model radio unit available from Gateworks.

When configured in this example embodiment, the radio modules 316 are a carrier grade PCI, or mini-PCI router board for enterprise and residential network applications. The radio modules may be quad board to support four antennas, or able to support any number of antennas. The device may be used in a wide range of outdoor applications such as WISP customer premise equipment, Mesh repeaters, WiMAX, any 802.11 type transmission, pico base stations, 3G-routers, wireless point to multipoint bridges and 3G to Wi-Fi routers and gateways. The frequency range may extend into the terahertz range. The radio module 316 may include numerous features including the Cavium® ECONA™ CNS3420 Dual Core ARM11 SoC processor operating at 600 MHz, 256 Mbytes of DDRII-400 DRAM, 16 Mbytes of System Flash, 4 Mbytes of Backup and Restore Flash, and two Gigabit Ethernet ports. In this embodiment, the radio module includes four type III mini-PCI sockets capable of supporting any combination of 802.11abgn radios, WiMAX radios, and other mini-PCI peripherals. The system may be configured for 3G CDMA/GSM modem support. The radio module 316 may include a wide-range DC input power supply which can source power to the PCI or mini-PCI sockets for supporting the latest high power radios. In other embodiments, other type sockets maybe used. The radio module 316 may be configured with a real time clock, voltage and temperature monitoring, general purpose digital I/O, serial EEPROM, programmable front panel switch, tamper switch and advanced power management with programmable board shut-down and wake-up for remote sensor applications. In on embodiment, there are eight 802.11 compatible radios in the unit and each radio is powered at 1800 milliwatts of output power. In this configuration, there would be sixteen wideband 5 db multipolar/multifeed antennas. 3.5 GHz WiMax radios may also be included, as could Bluetooth and GSM/LTE capabilities.

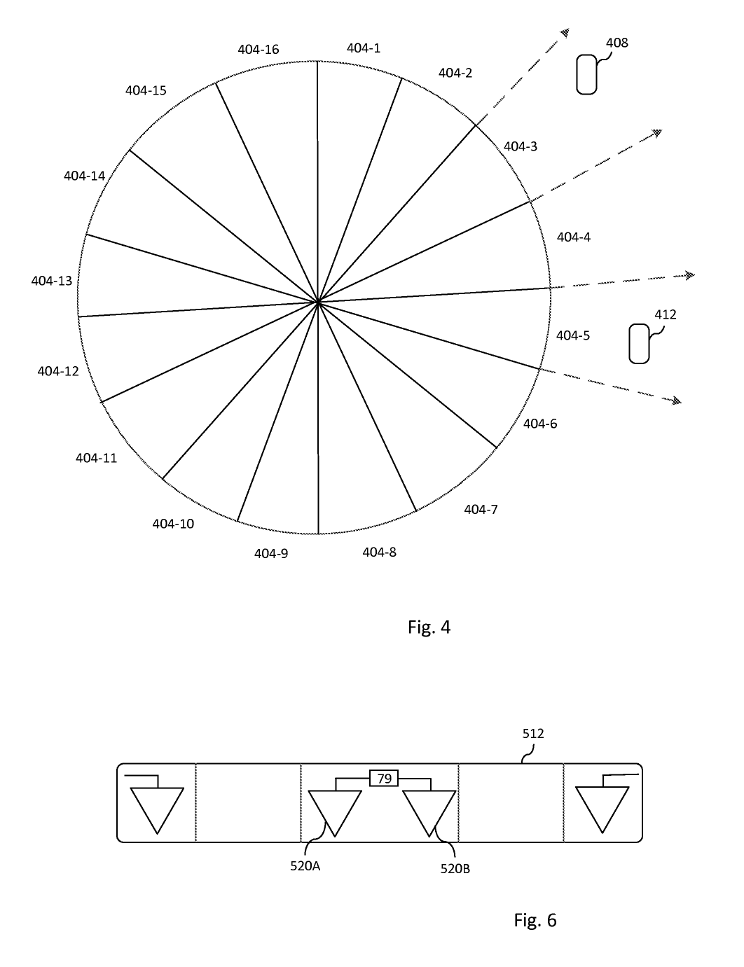

In one embodiment, the number of radio modules 316 corresponds to the desired number of antennas, while the number of antennas corresponds to the number of sectors presented for coverage by the antenna array. Each radio module is configured to have one or more antenna ports to which antennas connect. In one embodiment, each radio module is configured with 2 antenna ports. The antenna sectors are discussed below in greater detail in connection with FIG. 4.

In addition to the radio modules 316, the control board 304 includes additional chipsets and elements as would be understood by one of ordinary skill in the art. For example, in this configuration the control board 304 may include a CPU/CPUs 308, RAM (memory), EPROM, Ethernet or Fiber port, RS232, and USB Ports, each of which may either directly attach to the board or mount on its own circuit board then plug into a slot which can be either MiniPCI, PCIe (PCI Express) or other available bus slot extension format. It is contemplated that the CPU 308 of the radio module 316 may be the same as or different from the CPU of the central controller 82. In one embodiment, a single CPU can perform the processing of both the central controller 82 and the one or more radio modules 316. It is also contemplated that the system may be scalable such that any number of central controllers 82, radio controllers 316 and antennas may be configured for use in a single unit or an area wide system. The memory may be configured with or stored, in a non-transient state, machine readable code or machine executable instructions that are stored in the memory.

The radio module 316 can have two or more individual antenna ports for connecting one or more antennas 320. One antenna connects to each port.

The board 304 may be configured with four radio modules 316, thereby establishing eight antenna ports, with connected antennas, per radio board 304. Any type antenna may be used subject to the requirements of the frequency band and type of communication, as would be understood by one of ordinary skill in the art. Although for simplicity, only one radio module 316 is shown with connecting antennas but it is contemplated that each radio module will have antennas connected. In one embodiment the length and characteristics of the antenna connection 324, between the antennas 320 and the radio module 316, is generally similar. For example, in one configuration, the length and impedance of each antenna connection 324 is the same. Additional details regarding the antennas are discussed below.

An input/output (I/O) interface 312 is also part of the transceiver unit 79. The I/O interface serves to provide data to and receive data from the central controller 82. Using the I/O interface 82 the control board 304, and radio modules 316 contained on the control board 304, the transceiver unit 79 exchanged data and control signals with the central controller 82 (FIG. 2).

FIG. 4 illustrates a top view of an exemplary antenna sector layout for an antenna array having a circular coverage pattern. This is but one possible antenna array arrangement, and one of ordinary skill in the art may arrive at different antenna array layouts. Although shown in a two dimensional circular array, the array shape could be configured to cover other dimensions, such as a single dimension, for backhaul, point to point communications, or three dimensional, such as in a spherical or half sphere shape to cover a three dimensional shape, for users above, below, or above and below, the plane of reference.

In the example array shown in FIG. 4, the array may be well suited for a ceiling mounting which will radiate in a 360 degree pattern, such as for users walking or seated on a single level or range of level. Although shown as generally a planer array, the antennas may be located in different plane. For example, one antenna may be a ¼ inch higher than another antenna, while the next may be ½ inch lower or ¼ inch lower. This establishes the antennas in different planes. Coverage, due to signal dispersion, is also not planer but radiates upward and downward.

As shown in this example array, the circumference of the circle is divided into sectors 404-1 through 404-16. Each sector corresponds to a different antenna or antenna group. Such as with mobile devices 408, 412, a user having mobile device 408 is serviced by one or more antennas serving sector 404-3, while mobile device 412 is served by one or more antennas serving sector 404-5.

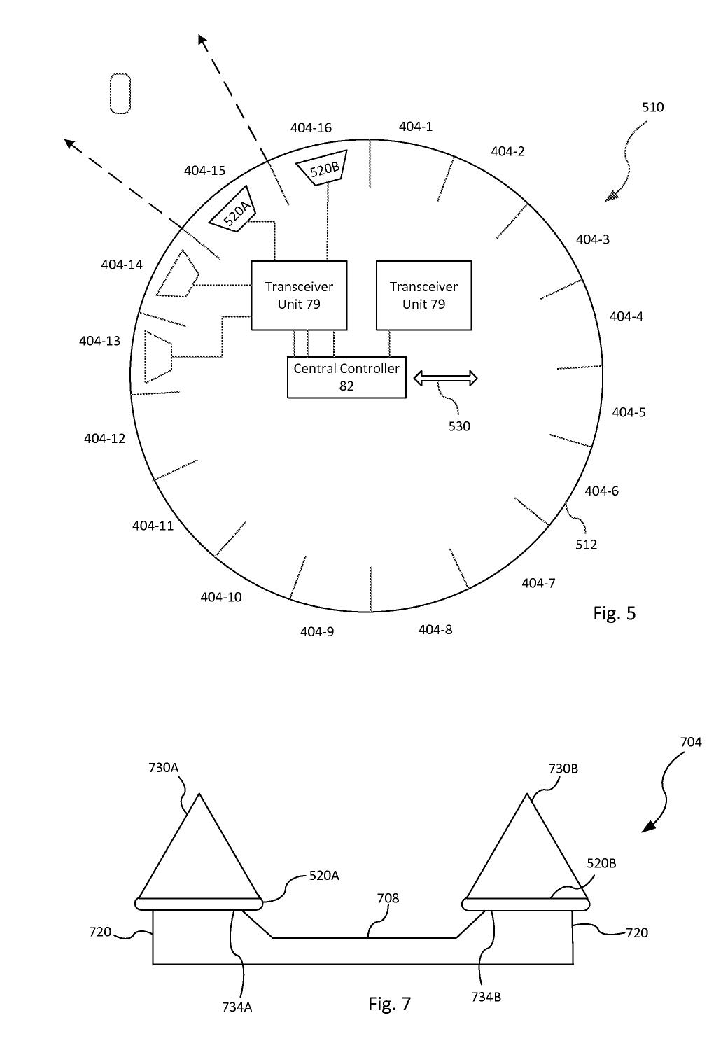

FIG. 5 illustrates a top view of an antenna array with paired antennas. This is but one possible configuration and as such, others may arrive at different configurations. In this example embodiment, the sector layout of FIG. 4 is adopted. Also illustrated is an optional outer housing 512 configured to contain and protect the internal components. Shown internal to the housing 512 is a central controller that communicates with the one or more transceiver units 79. One or more antennas 520 connect to the transceiver units 79 through the single conductor as shown. In this embodiment, antenna 520A and 520B form an antenna array. This antenna array formed by antenna 520A, 520B covers a sector formed by arcs 404-15 and 404-16. In this configuration, each sector is 45 degrees and 8 antenna arrays cover the full 360 degree circumference of the housing 512. Each arc 404-15 is 27.5 degrees, with two of the arcs 404-15, 404-16 covering 16 degrees. Sixteen total antennas 520 are utilized such that there are two antenna per antenna array. In other embodiments, other coverage's and antennas per array are contemplated.

In one embodiment, the antennas and system have 23 dbm of gain. As is understood, the antenna itself can have gain which increases the magnitude of the signal. In other embodiments, other gain values may be presented. In one embodiment the channels are offset such that adjacent channels (frequency bands) are not located in adjacent sectors. In one embodiment all the sectors operate in the 2.4 GHz frequency band.

In this embodiment, only one central control 82 is shown but in other embodiments any number of central controllers may be enabled for operation. Likewise, while only a limited number of transceiver units 79 and antenna 520 are shown, it is contemplated that each sector (404-15 & 104-16) would be configured with one or more antenna and each antenna would connect to a transceiver unit 79 (or equivalent). In this embodiment, each transceiver unit has four antenna ports and hence it is able two sever four antennas (two antenna arrays), but in other embodiments the transceivers 79 may have a greater or fewer number of antenna ports. Each antenna will have overlapping coverage (reception) with adjacent antennas and even non adjacent antenna. Because each antenna is polarized (aligned) differently than adjacent antenna, an incoming signal, which may not be received by one antenna (due to alignment of the radio signal) will be received by the other antenna in the array, which in turn improves signal reception performance.

It is contemplated that in this example embodiment, the frequency bands or channel or adjacent sectors is alternated, such as for example, a repeating pattern of 2 GHz, 4 GHz, 5 GHz, and 8 GHz. The antennas are configured to operate in the 2-11 GHz range.

Also shown in FIG. 5 is a communication path 530 over which data may be exchanged with the communication unit 510 such as from external sources, including remote servers and other sources in private and public networks. The communication path 530 may comprise any type or format of communication path or connection. In one example embodiment, the device has 16 antennas and two antennas connect to a single radio module. This results in 8 radio modules per central controller. While each radio module has two antennas connected, in other embodiments any number of antennas may be connected.

FIG. 6 illustrates a side view of the exemplary antenna sector layout as shown in FIG. 5. As shown, the housing 512 encloses the antennas 520A, 520B. The antennas 520A, 520B connect to a transceiver unit 79. In this embodiment the antennas are configured as a first antenna 520A and a second antenna 520B. These antennas are referred to herein as an antenna pair 520, both of which connect to a common transceiver unit 79.

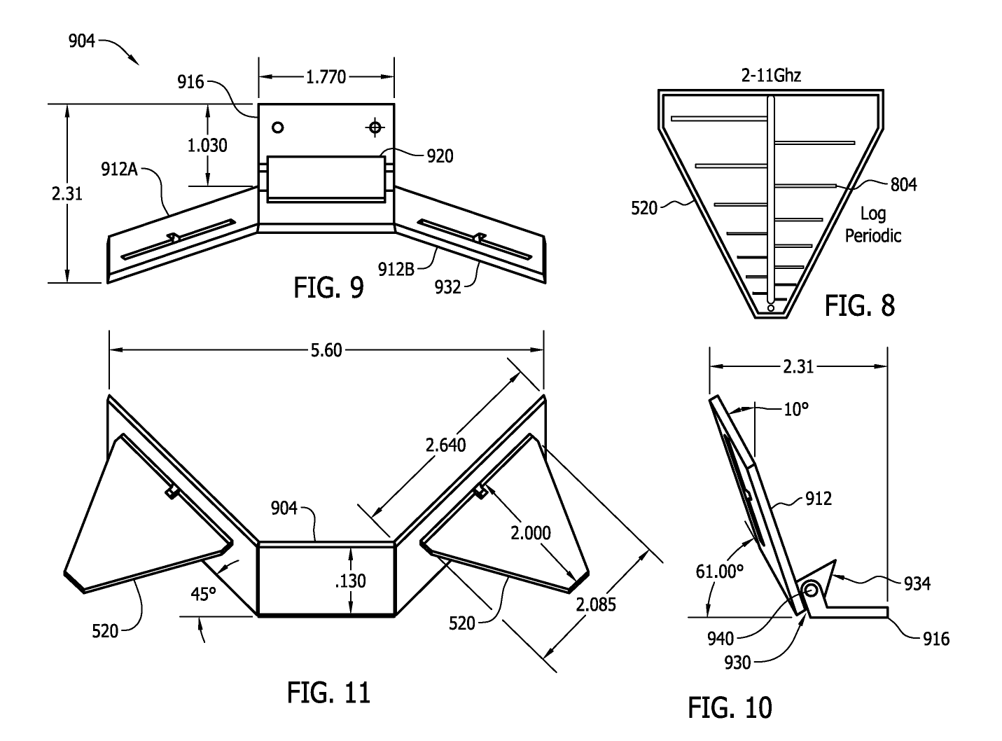

In one embodiment, each of the antennas are generally identical and aligned at minor but offset angles. Also shown in FIGS. 8-11, as shown the angles of the central axis of the antennas 520A, 520B, when mounted to a bracket or otherwise mounted, form a 90 degree angle to establish a multi-polarized configuration Likewise, the connection path between each antenna 520A, 520B and the transceiver unit 79 may be configured generally physically and identical electrically. This reduces reflection and maintains the signal alignment and timing between the antennas as generally identical. Although shown with each antenna around the circumference of the antenna array being located in the same plane, it is contemplated that some antennas may be located at different heights in relation to other antennas or antenna pairs in the communication device. This height may range from ⅛ of an inch to inches.

FIG. 7 illustrates a side view of an exemplary antenna pair. This is but one possible antenna arrangement. As shown, a mounting bracket 704 is provided for the first antenna 520A and second antenna 520B. The bracket 704 includes a center connector brace 708 between antenna support element 720. Each antenna support element 720 supports the antenna 520A, 520B at an angle which may be configured as identical but offset angles. The positions of the antennas 520A, 520B may be such that an axis of the antenna 520A, 520B intersect, if extended beyond the antenna, at 90 degree angles.

The antennas 520A, 520B shown in FIG. 7 may be offset and angled such that the antenna angles outward from the view directly into FIG. 7. In one embodiment, the antennas are angled at angle and also with the antenna tip 730A, 730B being located more distant to each other than the ends 734A, 734B of the antenna. In other embodiments other configurations are possible.

FIG. 8 illustrates an exemplary antenna. In the example antenna configuration shown in FIG. 8, one antenna 520A or 520B is configured as a log periodic antenna. In this embodiment the antenna is tuned from 2 to 11 GHz, but in other configurations the antenna 520 may be tuned or configured to any other frequency range. The lengths and spacing of the elements 804 of a log-periodic antenna increase logarithmically from one end to the other. It is normal to drive alternating elements with 180° (it radians) of phase shift. This is normally done by connecting individual elements to alternating wires of a balanced transmission line. In one embodiment the antenna has 11 dB of gain.

It should be noted that the “log-periodic shape” does not provide with broadband property for antennas. Actually, broadband property of log-periodic antenna comes from self-complementary antenna that always has constant input impedance, independent of the frequency and its shape. This antenna design is used where a wide range of frequencies is needed while still having moderate gain and directionality.

FIG. 9 illustrates an exemplary mounting bracket. The bracket 904 is configured to hold the antenna shown in FIG. 8. The bracket 904 includes a mounting bracket 916, a first wing 912A, and a second wing 912B. Each wing 912 includes a slot or other mounting mechanism to mount the antenna of FIG. 8 to the bracket 904. The dimensions shown are for one example embodiment. In other embodiments the dimensions may change.

FIG. 10 illustrates a side view of the mounting bracket shown in FIG. 9. As shown, the base 916 connects to the first side and second side 912 through either a fixed connection or a hinged pivot 940. To control the maximum rotation of the sides 912 in relation to the base, a tilt stop 930, 934 is provided to control upward and downward rotation. In one embodiment, the sides may rotate 10 degrees backwards from 61 degrees off horizontal as shown. In other embodiments, other amounts of rotation may occur. In one embodiment, the rotation is ten degrees in each direction for a total of twenty degrees tilt. In another embodiment, the rotation is twenty degrees in each direction for a total of forty degrees tilt.

FIG. 11 illustrates a front perspective view of the bracket 904 with antenna 520. This is the perspective located above and looking into the side view shown in FIG. 6. As can be seen the antennas 520 point outward and are angled 45 degrees from the vertical plane as shown. The antennas 520, which may be PCB bases with electrical conductors on the PCB, mount in the slots 932 shown in FIG. 9.

The numeric angles and distances listed in FIGS. 8-11 are provided as one example embodiment. In one embodiment the numeric values range in value +/−5%. In another embodiment, the numeric values range in value +/−10%. In other embodiments the numeric values range in value +/−20%.

It is contemplated that an arm or other connector may extend from the servo discussed above in FIG. 2 to control the position of the first and second arms 912 to thereby provide manual or automatic adjustability of the arms 912.

In an automatic adjustment scheme, the control dynamic or real time control over the position of the arms which in turn adjusts the position of the antenna relative to a horizontal plane. In other embodiments, the arms may rotate inward and outward relative to each other to change the distance between each side 912. Because the antennas of FIG. 8 are connected to each side, the location and angle of the antennas will likewise change. This will affect the location of maximum signal strength and range. Interference may also be adjusted. This can be done manually, with or without servo control. In one embodiment the antenna is glued or otherwise secured to the bracket.

It is contemplated that in one embodiment the system of FIG. 2 is able to automatically monitor and adjust the position of the arms 912 of the mounting bracket by controlling the position of the servo, which is connected to the bracket. For example, the central controller or CPU associated with a transceiver unit 79 may monitor wireless data traffic to determine where users are located or whether existing users are able to have improved communications through adjustment of one or more angles of the bracket 904.

In one embodiment a software application is executed on a mobile communication device, table, or laptop to exchange data with the central node (access point) to determine signal power levels at both devices. As the portable device is at various locations, the servo motor may move the antenna bracket to reposition the antenna. The application executing on the portable device will detect and provide real time feedback to the central node (access point) and the servo motor (or stepper motor) to establish the servo position at the position or location which gives the best signal strength, throughput or both, to the one or more locations of the portable device. The servo position may also be adjusted in real time during use to maximize throughput or other factor during operation depending on user distribution and traffic. Any type device or mechanism may be used to move the antenna and/or brackets to which the antennas mount. The antennas may be movable between two positions, or a plurality of positions.

In operation, electrical signals are presented to the antenna pair shown in FIG. 11 and due to the arrangement and angle of the antennas, the signals are transmitted on multiple axis. By transmitting on multiple axis, it is possible to present more of the signal components and magnitude at a receiving device than if transmission was on a single axis. This increased received signal magnitude may not be present with some measurement techniques. As a result, data throughput is increased. Another benefit is increased range and an ability to serve a greater number of users.

With regard to an incoming signal, as the signal arrives at the unit, it hits both antennas of the antenna pair at the same time. The antennas convert the received EMF energy to an electrical signal. While prior art antennas are vertically or horizontally polarized, the antenna alignment disclosed herein uses antenna pairs, both of which are log periodic offset and angled as shown above. As a result, a signal arriving at or leaving the antenna has a rotating field, with a non-vertical and non-horizontal polarization thereby providing signal strength after encountering an object in the wireless signal path that would otherwise block or reduce the signal magnitude.

When an antenna receives the signal and the signal polarity matches the antenna polarity, the EMF energy is transferred to the antenna and converted to electrical energy. By having multiple linked antennas with different polarity, the effective amount of energy transmitted and received is increased. The signals transmitted by the antenna pair are angled to thereby have the signal from each antenna intersect. This can cause overlaps and reinforcement of the signal. During receipt of a signal, the antenna receives both signals at the same time, such that even if one antenna and its unique polarization is unable to receive the signal, the other antenna, and its unique polarization, is able to receive the signal. This may be referred to as a multi-polarized signal.

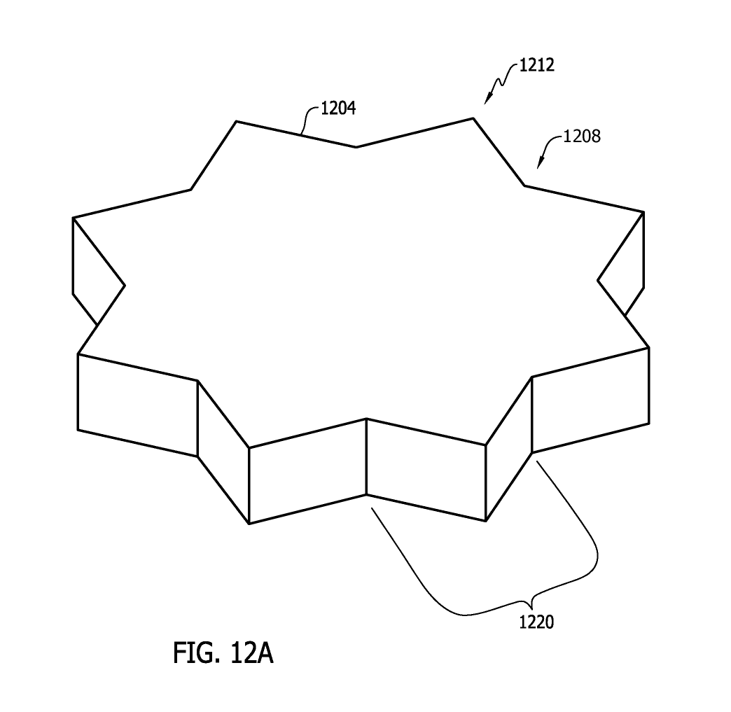

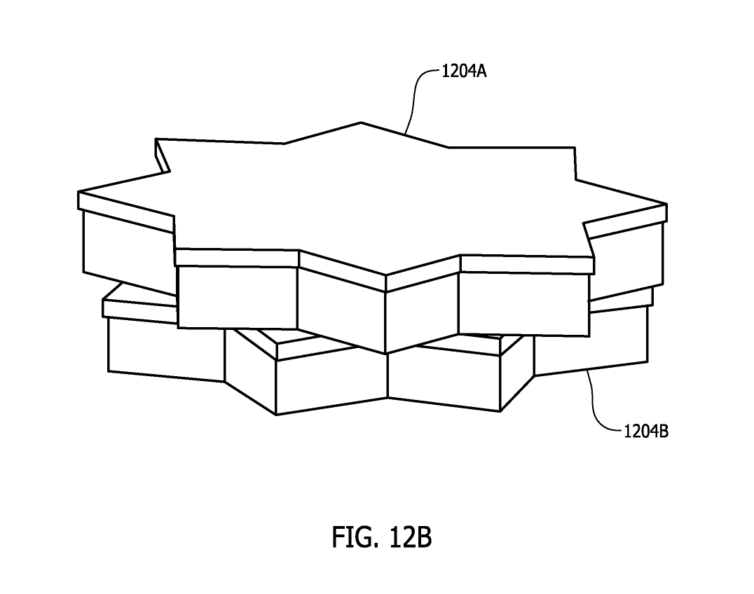

FIG. 12A illustrates a perspective view of an exterior housing or an eight radio base station. This is but one possible design configuration and it is contemplated that one of ordinary skill in the art may configure other arrangements and shapes. In this configuration of the housing 1204 includes eight interior points 1208 and eight exterior points 1212. Each section 1220 (eight around the circumference of the housing 1204) is configured as a sector and is configured with an antenna array pointing outward.

FIG. 12B illustrates a perspective view of an exterior housing or two stacked eight radio base stations to form a 16 radio configuration. FIG. 12B illustrates two eight radio units as shown in FIG. 12A in a stacked and offset configuration. In this stacked and offset configuration, the unit is able to support 16 radios. By offsetting each stacked radio, each sector is covers a smaller arc of a circle or fewer degrees. The circle id defined by a circle around the housing. In other embodiments, other configuration may be used. In addition, it is contemplated that each antenna or antenna array within a radio may be at a different elevation.

By stacking radios, layers of communication may be created even within a certain sector such that different layers may be configured for different uses or for selected users.

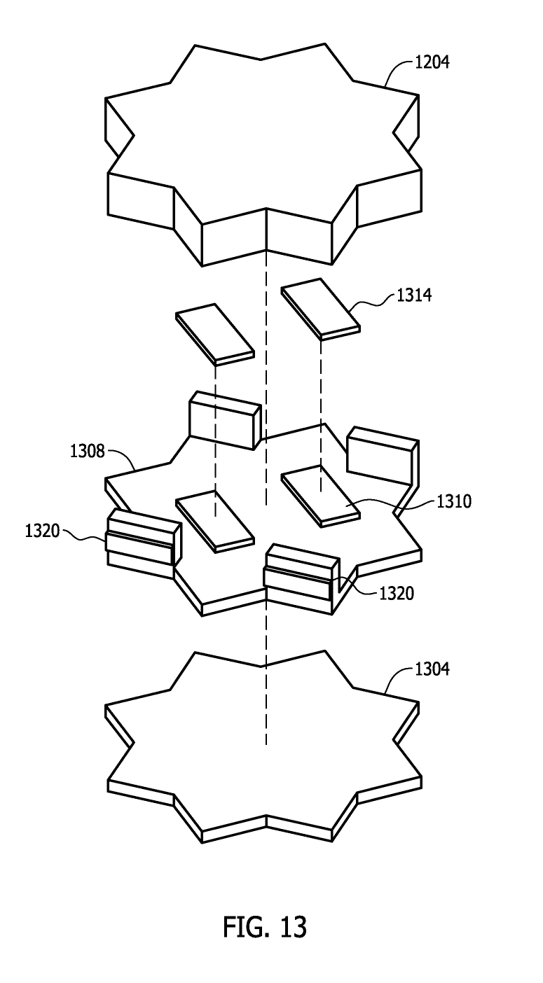

FIG. 13 illustrates an expanded view of a 8 radio base station. In this example embodiment, the housing 1204 forms the top and side edges. The cover may be made of plastic, resin, or any material that does not interfere with the radio signals. Opposing the top of the housing 1204 is a base mounting plate 1304. In one embodiment the base mounting plate 1304 is made of aluminum, but in other embodiments other materials may be used. It is contemplated that the base plate (mounting plate) that may be aluminum, may be round.

Between the housing 1204 and the base mounting plate 1304 is a printed circuit board (PCB) 1308 to which radio control boards 1310 mount. The PCB may be fiberglass based. One or more shielding panels 1310 are provided to shield the radios control boards 1310 or other elements within the housing from EMI. Also part of this configuration are one or more antennas 1320. Although shown with only two antennas 1320, it is contemplated that each face of the outer edges of the mounting base plate 1304 may have an antenna 1320 facing outward. Each antenna may be part of an array and commonly connected to a single radio. Although shown in FIG. 13 with two radios control boards 1310, it is contemplated that additional or fewer radio control boards may be provided. Each radio control board may have more than one radio. Additional shielding 1314 may optionally be placed near the antennas. In one embodiment, the top or sides of the housing may have one or more LED to display a logo or operating information.

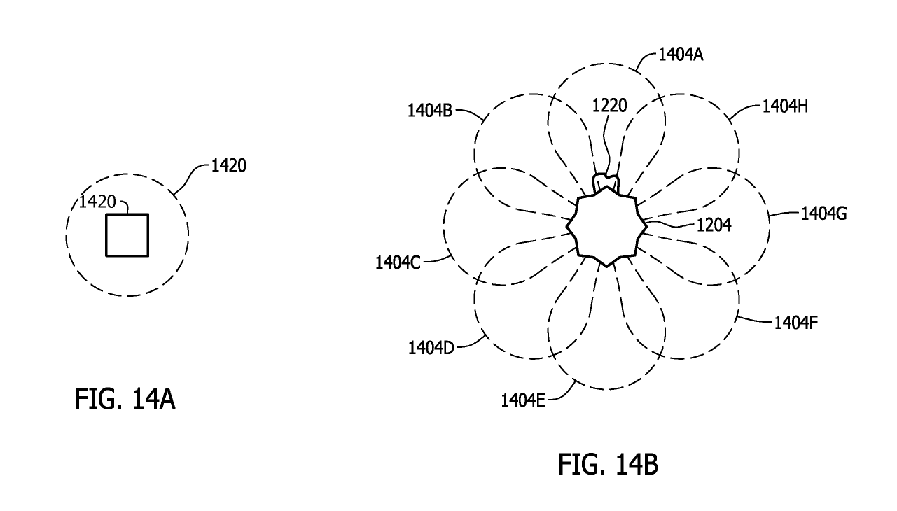

FIG. 14A illustrates a prior art base station 1418 with coverage area 1420. Because only one or two antennas are used and the coverage area for each antenna is circular, the entire transmit power for each antenna is spread over a circular area thereby reducing the coverage area in any one direction.

FIG. 14B illustrates coverage areas for each antenna in the radio configuration of FIG. 13. As shown, the outer circumference facing outward is divided into sectors 1404 and each antenna array 1220 serves a sector 1404. The array may be two or more antennas which connect to a common radio to process communication occurring within that sector 1404. The sectors 1404 may overlap. As a user moves between sectors, that user may be handled off to the adjacent sector, or the user may be dropped and reconnected with a different sector or different node. As shown, each sector 1404A-1404H extends outward as shown. As compared to the prior art coverage of FIG. 14A, because each sector covers a shorter arc (fewer degrees) the entire power assigned to the antenna array 1220 is dedicated to that sector and thus the range and capacity for that sector is increased. In addition, certain sectors 1404 may be selectively turned off or enabled to suit a particular environment, or the maximum power a radio and antenna pair for a sector may be adjusted to meet the desired coverage range while also minimizing interference with other sectors or nodes. As used herein, the term node is another radio or base station.

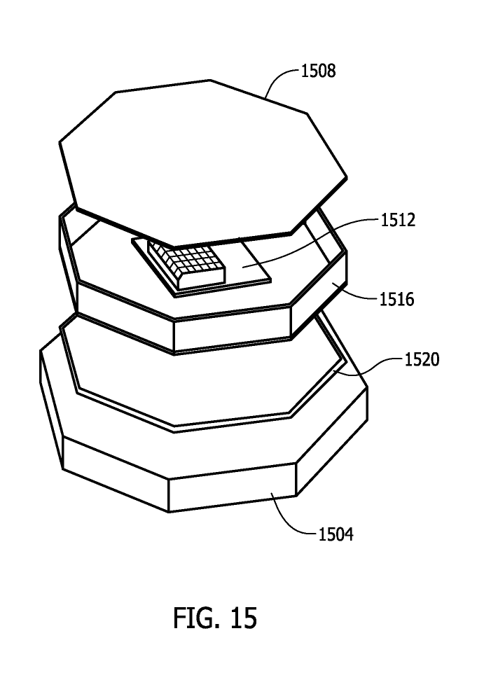

FIG. 15 illustrates an expanded view of an alternative embodiment of a radio configuration. In this embodiment, the housing is octagonal. Each of eight sides may be configured with an antenna array, two adjacent sides maybe configured with an antenna array. As part of this embodiment a base housing 1504 include the base and sides extending upward from the base. This element may be referred to as a enclosure lower and may have one or more optional light emitting diodes. Within the base housing 1504 is an aluminum mounting plate 1520. On top of the aluminum mounting plate 1520 is a fiberglass PCB 1516 with one or more radio boards 1512 mounted or connected to the PCB 1516. Each radio board 1512 may support and have more than one radio connected thereto. A top lid or enclosure cover 1508 connects or otherwise mates to the lower enclosure 1504 to enclose the radio board 1512, PCB 1516 and mounting place 1520.

Alone or in any combination, any devices and embodiments described above may be configured with any of the features described herein including the following. The communication system may include WIPS (Wireless Intrusion Protection Systems) including active & passive capabilities as well as rogue node detection and anti-hack/anti-DOS (Denial of Service) capability. The communication devices and embodiments may also be configured with communications encryption, user authentication and verification. The signal ranges may be from 1000 meters to up to 10,000 meter depending on area & region regulations. The systems may use multi-polar cellular style antenna array. Some embodiments may use or be configured with built-in GPS/RF triangulation capability and geo-fencing available as a mobile device application. In addition, the devices may be configured with MESH communications capability allowing each base station to communicate with other base stations. The systems may be self-healing multi-radio/multi-frequency/multi-layered environments. As discussed above, the antenna may be of a multi-polar and configured to capture RF (Radio-Frequency) signals on horizontal, vertical & z-axis (three axis). The system may be configured with multi-fed (MIMO Compatible) and/or direct broadcast video WiFi transmission (DBVW).

The system is configured with multiple channels per frequency and there is the option to have multiple frequency radio. The system may be compatible with GSM, LTE, CDMA, and WiMAX. In addition there are certain customized frequencies between 175 MHz-6 GHz and is operable with DOCSIS including DOCSIS 3.0.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A communication device comprising
two or more antenna arrays, each array comprising two or more antenna pairs, the antenna pairs including a first antenna and a second antenna linked to a shared radio, the first antenna and the second antenna configured to receive an same incoming wireless signal and wirelessly transmit an outgoing signal;
two or more radios, each of the two or more radios connected to one or more antenna arrays and comprising:
a receiver configured to receive the incoming wireless signal from the antenna pair and process the incoming wireless signal to create received data;
a transmitter configured to process outgoing data into an outgoing signal and present the outgoing signal to the antenna pair;
an interface configured to connect to a wired communication channel, the interface configured to send received data from the two or more radios to the wired communication channel and present outgoing data from the wired communication channel to the two or more radios;
a central controller in communication with the two or more radios and the interface to control the exchange of outgoing data and received data between the interface and the two or more radios.

2. The communication device of claim 1, wherein the first antenna and the second antenna are symmetrically offset and angled from a center axis, the center axis defining a center axis of a sector served by the first antenna and the second antenna.

3. The communication device of claim 1, further comprising electrical connections between each antenna array and each radio such that electrical connectors of an antenna array are identically matched for physical characteristics and impedance.

4. The communication device of claim 3, wherein the first antenna and the second antenna are established at a different angle and are configured to receive the same signal but present a different signal magnitude to the radio due to the different angle of the first antenna in relation to the second antenna.

5. The communication device of claim 1, wherein the antenna arrays are assigned to a single sector and the coverage area of the communication device is divided into multiple sectors.

6. The communication device of claim 5, wherein the coverage area is circular and each sector is defined by an arc in the circular coverage area.

7. The communication device of claim 1, wherein at least one antenna pair is movable between a first position and second position during operation of the communication device based on control signals from the central controller.

8. A base station for wirelessly exchanging data between a remote server and a mobile communication device, the base station comprising:
a housing having a top, a bottom, and an outer side wall defining an outer circumference;
an input/output interface configured to connected to a communication cable and control the sending of received data over the communication cable;
two or more antenna arrays configured to receive and convert wireless signals from mobile devices to electrical incoming signals, at least one of the antenna arrays comprising:
an antenna bracket, the antenna bracket establishing a central axis;
a first antenna positioned on the antenna bracket facing toward the outer side wall at a first angle relative to the central axis;
a second antenna positioned on the antenna bracket facing toward the outer side wall at the first angle relative to the central axis but in an opposing direction;
a radio associated with each antenna array, the radio configured to receive and process the incoming signals from the antenna array;
a central controller configured to coordinate operation of the radios and the input/output interface to establish transmission of the incoming signals over the communication cable as data signals.

9. The base station of claim 8, wherein the antenna arrays are aligned to face the outer circumference of the side wall and extend in a generally circular layout around the outer circumference.

10. The base station of claim 9, wherein the outer circumference is divided into four or more sectors and each sector is assigned an one or more antenna arrays

11. The base station of claim 8, wherein the first antenna and the second antenna are log periodic antennas.

12. The base station of claim 8, wherein each radio connects to at least one antenna array, and each antenna array includes at least two antennas.

13. The base station of claim 8, wherein the base station includes eight antenna arrays and each antenna array consists of two antennas.

14. The base station of claim 8, wherein the antenna mount is movable between a first position and a second position to concurrently change the position of both the first antenna and the second antenna.

15. A radio system and antenna array for a wireless communication device, the radio system and antenna array configured to send and receive wireless communication in a sector comprising:
two or more radios configured to processes signal from two or more antennas;
two or more antenna arrays, each antenna array comprising two or more antennas, each of the antennas in the antenna array connected to the same radio and the antenna array assigned to handle communication in only one sector, the sector being less than a total coverage area for the wireless communication device, and each of the antennas comprising a log periodic offset and mounted in a mirrored offset and angle relative to the other antennas in the antenna array to establish wireless signals transmitted from an antenna as having a rotating field with non-vertical and non-horizontal polarization.

16. The system of claim 15, wherein each antenna in the antenna array has a different rotating polarization which is non-vertical and non-horizontal polarization.

17. The system of claim 15, wherein each radio services two or more antenna arrays and each antenna array presents the same signal to the radio.

18. The system of claim 15, further comprising a central controller and an input/output interface, the central controller configured to coordinate operation of the two or more radios with the input/output interface.

19. The system of claim 18 wherein the central controller is further configured to adjust an angle of all the antennas in at least one antenna array relative to a horizontal plane.
